(19) United States
(12) Patent Application Publication
(10) Pub. No.: US 2009/0236368 A1
(43) Pub. Date: Sep. 24, 2009

(54) Systems and Methods for Protecting Alcoholic Beverages in Containers from Deterioration

(76) Inventor: Christopher E. Coon, San Clemente, CA (US)

Correspondence Address: THE NATH LAW GROUP, 112 South West Street, Alexandria, VA, 22314, US

(21) Appl. No.: 12/306,540

(22) PCT Filed: Jul. 2, 2007
(86) PCT No.: PCT/US07/15380

§ 371 Date: Jan. 15, 2009

Related U.S. Application Data
(60) Provisional application No. 60/817,938, filed on Jun. 30, 2006.
(60) Provisional application No. 60/818,637, filed on Jul. 5, 2006.

(51) Int. Cl. B67D 1/08

(52) U.S. Cl. 222/152

(57) ABSTRACT

The present invention relates generally to the field of alcoholic beverage preservation. More particularly, this application relates to protecting an alcoholic beverage from deterioration once opened.

### FIELD OF THE INVENTION

This application is in the field of alcoholic beverage preservation. More particularly, this application relates to protecting alcoholic beverages in containers from deterioration by oxidative forces or biological (e.g., microbial) forces once opened.

### BACKGROUND OF THE INVENTION

It has long been known that the act of uncorking a bottle of wine in an ambient air environment exposes the wine within the bottle to the oxygen present in the ambient air, which, on average, contains 21% oxygen by volume. This exposure initiates an oxidative deterioration of the wine that, once begun, cannot be reversed or arrested. In fact, it is to prevent the negative effects that inevitably result from the prolonged exposure of finished wine to oxygen that motivates vintners to bottle wine as soon as possible after fermentation ends. While no useful purpose would be served by specifying in detail each and every chemical oxidation and reduction reaction that takes place during the process of fermentation, it is worth noting that during the final reaction of the fermentation process, the organic chemical compound acetaldehyde is reduced to ethyl alcohol. This is worth noting because when a bottle of wine is uncorked, and the wine inside the bottle thus exposed to oxygen, this final chemical reduction reaction is reversed: that is, the ethyl alcohol present in the exposed wine is oxidized back into acetaldehyde. It is this oxidation reaction that ultimately accounts for the spoilage of wine, and its ultimate conversion to vinegar (acetic acid) and other foul-tasting chemicals, such as acetone.

The manner in which a bottled wine responds to prolonged exposure to oxygen upon uncorking depends on many factors. As a general rule, white wines tend to fare better than red varieties. Factors include the style of wine, the vintage, the winemaker's experience, and previous storage conditions: temperature, orientation of the bottle, etc. One aspect of a sommelier's training is to be cognizant of these factors and how they dictate how a bottle of wine is to be handled (length of aeration time, decanting, “breathing”). Older red wines are decanted to separate the “good” wine from the “bad.” (The “bad” aspect here refers to sedimentation, so the primary reason a sommelier decants an older red wine is to separate out the sediment that accumulates in bottled reds over the decades.) It is critical, however, to mention that once decanted, red wine that has been aged for decades succumbs to oxidation much more rapidly than younger reds, that is, reds that are uncorked before they have been permitted to fully age. The decanting of these younger reds tames the tannins that otherwise would have been subdued slowly over decades in the bottle, but once exposed to oxygen, all of the wine must be consumed in relatively short order (hours) if one hopes to capture the wine at its best. Waiting longer than this is not feasible, at which point the wine must be discarded.

In some wines, especially strong red wines with a proper balance of sugar, alcohol, tannins, and acidity, the conversion of ethyl alcohol to acetaldehyde can add to the complexity of the wine and heighten its bouquet (fruit aromas, taste, character), although too much acetaldehyde is a sign of spoilage. However, controlling the amount of oxidative byproducts in the opened bottled wine is complex. Thus, in the training of sommeliers, the style of wine, the vintage, the winemaker's experience, and previous storage conditions (temperature, orientation of the bottle, etc.) are all important factors.

As a general rule, once opened, white wines tend to fare better than the red varieties, although in due course virtually all wines convert to acetic acid and ethyl acetate upon prolonged exposure to ambient air, the notable exceptions being the so-called fortified wines (e.g., Port, Sherry, Madeira, and Marasala) which, to varying degrees, are more resistant to oxidation.

In addition to the oxidative deterioration brought about by the exposure of wine to oxygen upon uncorking a bottle of wine in ambient air, airborne microbes such as bacteria (both aerobic and anaerobic) also come into contact with the wine, initiating yet another type of deterioration.

To slow the deterioration of wines and other alcoholic beverages, they are most often stored and preserved in bottles that are sealed with a cork or similar sealing device. This is problematic, since the beverage in the bottle is not always consumed immediately after being opened. Accordingly, taste and other desirable characteristics become altered, and the beverage is often spoiled and has to be discarded.

Attempts to reduce the deterioration of wine and other alcoholic beverages have involved either limiting or eliminating the presence of oxygen to exposed wine surfaces. Because air contains approximately twenty-one percent oxygen by volume, simple procedures such as tightly replacing the cork and reducing the amount of air space or head space above the liquid level of the wine in the bottle are only marginally effective at limiting the deterioration of bottled wine.

Other, more complicated solutions for wine preservation are also known. The Vacu-Vin® Vacuum Wine Saver System, manufactured by Vacu-Products B.V. Corporation (Kalfjeslaan, The Netherlands) is a device used to manually evacuate the air from the head space inside a wine bottle to slow the deterioration of the wine and to extend the preservation of the wine after the wine bottle is opened. This device includes a rubberized stopper, similar to a cork, that fits within the neck of a wine bottle. The stopper forms a seal in the neck of the bottle that prevents air from entering the bottle, and remains in the bottle until the bottle is empty or discarded. A separate, mechanical, hand-held vacuum pump is attached to the top of the stopper and draws the air from the head space inside the bottle through the stopper and out of the vacuum pump attachment. A user pulls on a handle on the vacuum pump to draw the air out of the bottle. The user continues to draw the air out of the bottle by pulling on the handle of the vacuum pump attachment until a vacuum is created inside the wine bottle. Other known wine bottle vacuum devices combine the vacuum pumps with a dispenser, which enables the wine drinker or server to leave the stopper in place until the wine in the bottle is completely consumed. If the stoppers do not have a dispenser, then the stoppers have to be removed and replaced in the same manner as a cork. Even with the stopper, the user must remember to evacuate the head space periodically.

Head space evacuation also has a number of inherent problems. First and foremost, an evacuated head space has a sub-atmospheric pressure that works against whatever sealing configuration the stopper assumes in an attempt to draw in oxygen-laden air. In contrast, some nitrogen systems (described below) operate at a slightly elevated pressure inside the head space. These systems also work against the sealing stopper, but maintain a substantially inert atmosphere even if depressurized to atmospheric pressure.

Head space evacuation also suffers from being a manually conducted and imprecise mechanical procedure. More head space requires more pumping, and users attempting to judge whether they have pumped enough are likely to pump too little, leaving air in the bottle, or to pump too much, unduly stressing the stopper and the pumping mechanism. In short, known head space pumps do not consistently and reliably eliminate oxygen, do not provide positive pressure and require both a separate pump or stopper for each open bottle as well as undesired manual operation by the wine drinker or server. Thus, trying to replace the head space in a bottle of wine is logistically difficult. People enjoying a glass of wine typically do not want to contend with such detailed or specific procedures.

Other known wine preservation and dispensing devices use an inert gas to blanket the head space in a wine bottle. These systems use an inert gas such as nitrogen from a large gas storage cylinder or smaller portable containers. Several types of such nitrogen preservation systems are known. Some systems preserve only one wine bottle, and others preserve a plurality of wine bottles. Examples of such systems are disclosed in U.S. Pat. Nos. 4,477,477; 4,595,121; 4,691,842; and 5,139,179.

U.S. Pat. No. 4,477,477 discloses the introduction of an inert gas such as nitrogen into a wine bottle from a gas storage container such as a gas cylinder or gas cartridge. The inert gas travels through a tube and into the wine bottle. A sealing member is positioned around the tube and fits into the neck of the bottle to seal the bottle opening. The sealing member allows air to pass out of the bottle and inert gas to be supplied into the bottle. The inert gas replaces the air that would otherwise exist in the head space. Once the inert gas fills the head space of the wine bottle and a significant amount of the air inside the bottle is displaced, the sealing member and tube are removed from the bottle and the cork is replaced. This manual process is repeated each time the user desires to preserve the wine in the bottle after the bottle has been opened.

Similarly, U.S. Pat. Nos. 4,595,121 and 4,691,842 disclose devices for dispensing and preserving degradable liquids such as wine. These devices include a cap or stopper having a gas supply tube and a wine dispensing tube which is inserted into the opening of a wine bottle. The cap seals the opening of the bottle. A storage cylinder containing a non-degrading gas delivers the gas to the cap and into the wine bottle. The gas displaces the air inside the bottle. In U.S. Pat. No. 4,595,121, the cap or stopper disconnects from the gas supply tube and wine dispensing tube and remains in the wine bottle opening so that the user can store and preserve the wine for later use. In U.S. Pat. No. 4,691,842, the plug remains in the wine bottle until the bottle is empty.

Other known preservation systems employ a portable gas container which can be transported by a user and attached to an opened wine bottle at remote locations. One such device is disclosed in U.S. Pat. No. 5,139,179. In this device, a stopper is inserted into an open wine bottle to seal the bottle opening from the air. A small gas cartridge containing an inert gas such as nitrogen or carbon dioxide is then attached to the top of the stopper. When the cartridge engages the stopper, the cartridge releases the inert gas into the wine bottle. The inert gas displaces the air inside the bottle and promotes short-term preservation of the wine as well as the dispensing of the wine from the bottle. The gas cartridge is then disconnected from the stopper. The stopper remains in the wine bottle opening for storage and future use, if desired. Other known wine preservation devices use a small portable gas canister or gas cylinder bottle to supply an inert gas to a wine bottle.

All of the above devices use a gas container such as a gas cylinder to supply the inert gas to a wine bottle, and the use of each entails potential problems. For example, the systems that utilize large gas cylinders provide a plentiful supply of inert gas; however, the cylinders are large and, therefore, comparatively hard to obtain, store, and transport. Moreover, a large gas cylinder is unattractive and too bulky to store in a kitchen or other convenient location in a home. And while the small portable gas canisters and cartridges used in certain of the systems described above are small enough to store under a sink or cabinet, these systems are inherently limited because a canister or cartridge may only be used a limited number of times before running out of inert gas. Therefore, a user must store or transport several canisters or cartridges when using this type of system. Also, the canisters and cartridges must be replaced, which can be time consuming and expensive.

Most importantly, sealed and pressurized inert gas systems merely work to slow the effects of oxidation after an alcoholic beverage container closure (cork) has been removed. All such devices exhibit only a limited preservation window, which in fact proves that oxidation is not halted by these systems, but merely slowed down by inhibiting oxygen influx into the beverage.

Nitrogen is preferred in most of the wine preservation devices described above because nitrogen is an inert, non-flammable gas that is normally extracted from air in the atmosphere of the earth, which is approximately 78% nitrogen by volume. Other inert gases, such as argon, could be used in place of nitrogen. Argon, in particular, is understood to be one of the best blanketing gases because it is a heavy gas (approximately 1.4 times heavier than nitrogen) and tends to pool over a target area. Argon, however, makes up less than one percent of air and is therefore generally too limited and expensive to be used for such purposes.

Wine consumers can also purchase pressurized aerosol canisters of nitrogen, which are supplied with long, thin, straw-like injectors. One such system is the PRIVATE PRESERVE® wine-preservation system (Private Preserve, Napa Valley, Calif.) The injectors enable the person to inject an amount of nitrogen into the wine bottle to flush the air out of the bottle. This system, however, suffers in a number of respects. First, the system is inexact in that the wine drinker has no way of knowing how much air is left in the bottle. Second, as with the head space pumps, people are likely to inject too little nitrogen and create a less than optimal atmosphere, or inject too much and waste nitrogen. This system also requires the user to quickly replace a cork or stopper after filling the bottle or else risk losing the nitrogen to the atmosphere. Because oxygen is heavier than nitrogen in ambient air, the air tends to settle into a non-covered head space. Therefore, the process of removing a cork, even for a short period of time, likely causes air to enter the head space.

Unlike other nitrogen systems, the canister used in the PRIVATE PRESERVE® wine preservation system does not provide a positively pressurized head space for the wine bottle. The canister itself is limited in how much pressure it can hold and, more importantly, there is a pressure drop across the straw-like injectors, so that the nitrogen exits the injector at the pressure inside the head space, —that is, at atmospheric pressure. In short, existing nitrogen canisters do not have the ability to build pressure.

In a pressurized system, a gas such as nitrogen is supplied to a sealed wine bottle. As gas is supplied to the wine bottle, the pressure within the bottle increases. The pressure increases because the interior chamber space or volume of the wine bottle is fixed, yet more and more gas is being squeezed into that fixed space. To maintain an equilibrium, or equal level, of pressure with the ambient, or outside, pressure, the gas pressure inside the wine bottle will seek to equalize with the outside pressure. Thus, the force of the pressure within the wine bottle presses against the interior chamber walls of the wine bottle and the stopper to attempt to equalize with the lower outside pressure. The gas inside the wine bottle will therefore push through leaks or small openings around the stopper. Because the pressure inside the wine bottle is higher than the outside pressure, outside air will not be able to push or move into the wine bottle through the same leaks or openings.

In a non-pressurized system, the pressure inside the wine bottle is equal to the outside pressure. Therefore, outside air readily exchanges with the head space gas, which eventually leads to oxidation of the alcoholic beverage.

Known nitrogen systems that pressurize the head space of a wine bottle for wine preservation, such as those described above, include a pressurized or bottled source of nitrogen. The pressurized canisters or cylinders of nitrogen present certain issues for manufacturers and users. Each cylinder or canister must have the proper wall thickness and be welded together or formed according to industry regulation. These systems also have fittings and tubing and gas flow components that are rated based on the operating pressure of the system. Nitrogen systems operating at higher pressures require more robust materials and components, and accordingly are more expensive. Systems operating at lower pressures require more frequent refilling.

When the pressurized canisters or cylinders of the known nitrogen systems depressurize completely and thereby run out of nitrogen, the systems can no longer preserve wine until the person refills the canister or cylinder. The canisters or cylinders are refilled in two ways. The wine drinker typically discards a low pressure canister and replaces it with a new, pressurized canister. These low pressure gas canisters are relatively expensive. For a high pressure system, the person must take the high pressure canister or cylinder to a cylinder filling shop for a refill. Cylinder filling shops are not always readily accessible and transporting high pressure cylinders increases the risk that a cap or valve may come loose.

As indicated above, champagne is also a widely consumed beverage that is enjoyed all over the world for its taste and bubbly characteristics. Many types and brands of champagne exist in the market today. The known preservation and dispensing devices described above may also be used to preserve and dispense champagne. As with wine, the taste and character of champagne immediately begins to deteriorate oxidatively after a bottle is opened. In addition, the exposure of the champagne to the lower pressure in the atmosphere enables the bubbles in the champagne to escape. As the bubbles escape, the bubbly quality of the champagne decreases until there are no bubbles left in the champagne.

Accordingly, a need exists for a reliable, safe, and efficient alcoholic beverage (e.g., wine and champagne) preservation and dispensing apparatus that uses an inert gas such as nitrogen, which is able to consistently and reliably pressurize the head space of a wine or champagne bottle.

### SUMMARY OF THE INVENTION

The present invention provides an alcoholic beverage protection system for reducing deterioration of a beverage in a beverage container. One of the many features of this system is that it facilitates the exchange of an alcoholic beverage container closure (e.g., a cork, lid, cap or stopper) with a tapping device in a substantially atmosphere-free environment inside the hermetically sealable chamber. By “atmosphere-free” it is intended that the gas inside the chamber is both substantially free of oxygen and microbial contaminants when the exchange takes place.

In one embodiment, the beverage protection system includes a hermetically sealable chamber having an opening for receiving one or more beverage containers, a platform disposed within the chamber for supporting one or more beverage containers, one or more actively controllable gas inlet and outlet ports in communication with the chamber, and a pressure gauge operatively coupled to the chamber. The gas inlet ports are connected to a gas supply system, whereas the gas outlet ports are connected to a vacuum system. The gas inlet and outlet ports are typically controlled using gas valves attached to each port. The gas inlet and outlet ports are operably configured to effect a positive or ambient pressure, and a negative pressure, within the hermetically sealable chamber. Accordingly, the chamber pressure can be manipulated during chamber usage to evacuate atmospheric gases from the chamber, and to fill the chamber with inert gas as appropriate.

In another embodiment, the hermetically sealable chamber of the alcoholic beverage protection system is combined with a tapping device, so a tapping device that further protects the beverage from deterioration can be exchanged with a conventional beverage container closure without exposing the beverage to the atmosphere.

In another embodiment, the system also includes a vacuum pump and a gas tank. The chamber may also incorporate a transparent top to allow the operator to easily view the beverage containers inside the chamber.

In addition, the system may also include a platform riser disposed within the chamber and operably connected to the platform to raise the platform up and down.

The alcoholic beverage protection system may also include one or more flexible gloves sealably connected to the chamber through one or more corresponding openings in the chamber.

In still another embodiment, there is provided a method of exchanging an alcoholic beverage container closure with a tapping device to reduce deterioration of an alcoholic beverage in an alcoholic beverage container, comprising the steps of: a) providing a hermetically sealable chamber having at least one sealable opening for receiving at least one beverage container, and at least one actively controllable gas inlet port and at least one actively controllable outlet port; b) placing the alcoholic beverage container and the tapping device into the chamber; c) removing atmospheric gases and microbial contaminants from the chamber; d) filling the chamber with an inert gas; and e) exchanging the closure with the tapping device.

Other embodiments of the present invention are described throughout the specification.

### BRIEF DESCRIPTION OF THE DRAWINGS

FIG. 1 is a first perspective view of one embodiment of an alcoholic beverage protection system in accordance with the present invention.

FIG. 2 is a second perspective view of one embodiment of an alcoholic beverage protection system in accordance with the present invention.

FIG. 3 is a third perspective view of one embodiment of an alcoholic beverage protection system in accordance with the present invention.

FIG. 4 is a top schematic view of one embodiment of an alcoholic beverage protection system in accordance with the present invention, wherein the platform contains six bottle holders.

FIG. 5 is a side schematic view of one embodiment of an alcoholic beverage protection system in accordance with the present invention.

FIG. 6 is a perspective view of a cylindrically shaped embodiment of an alcoholic beverage protection system in accordance with the present invention.

### DETAILED DESCRIPTION OF THE INVENTION

The present invention provides an alcoholic beverage protection system for protecting the beverage in a beverage container from deterioration once opened. In general, the beverage protection system comprises a hermetically sealable chamber having an opening, a platform disposed within the chamber for supporting one or more beverage containers, one or more actively controllable gas inlet ports, one or more actively controllable gas outlet ports, and a pressure gauge operatively coupled to the chamber.

The alcoholic beverage protection system the present invention prevents alcoholic beverages from coming into contact/being exposed to the atmosphere, thus causing oxidative deterioration and aerobic and anaerobic microbial breakdown that result when a alcoholic beverage protection device is first opened (i.e., uncorked) and then subsequently closed (i.e., recorked, or fauceted) in an oxygen-containing environment and in which the recorking faucet has not been scrupulously disinfected in an alcohol disinfectant bath. The alcoholic beverage protection system allows an operator to create a substantially oxygen-free environment in which one or more containers of alcoholic beverages can be opened for the first time and then closed with a tapping device, such as a Cruvinet-style faucet, in a substantially oxygen- and bacteria-free environment, thereby preventing or slowing deterioration, whether chemical (oxidative) or bacterial (anaerobic), of the alcoholic beverage that otherwise would result and allowing greatly increased quality of alcoholic beverages.

The beverage protection system is particularly suitable to protect alcoholic beverages, such as wines and champagnes, from deterioration. The beverage protection system may be adapted for use with various types of containers, including commercial bottles and cans of various sizes. The hermetically sealable chamber of the present invention is dimensioned to receive one or more alcoholic beverage containers of common sizes.

The platform, as well as the system chamber, may be in various shapes, including square, cylindrical, oval, etc. In addition to supporting the beverage containers, the platform may also be configured to securely hold the containers to prevent accidental spills. When the platform is used as a beverage container holder, the hermetically sealable chamber may have a plurality of exchangeable platforms of various configurations for use with different sizes of beverage containers.

The opening on the hermetically sealable chamber for receiving beverage containers leads to the inside of the chamber. The opening is a sealable panel, such as a door secured on one side to the chamber.

Each of the actively controllable gas inlet and outlet ports may traverse through the chamber via a single hole in the chamber. Alternatively, some of the ports may also traverse through the chamber via multiple holes in the chamber. The term “actively controllable” is intended to mean that the flow of gases into and out of the ports can be controlled, such that both a positive and negative pressure inside the chamber can be easily achieved.

Suitable gases for use with the alcoholic beverage protection system are non-oxidizing gases, including nitrogen (N₂), carbon dioxide (CO₂), and inert gases, such as argon (Ar).

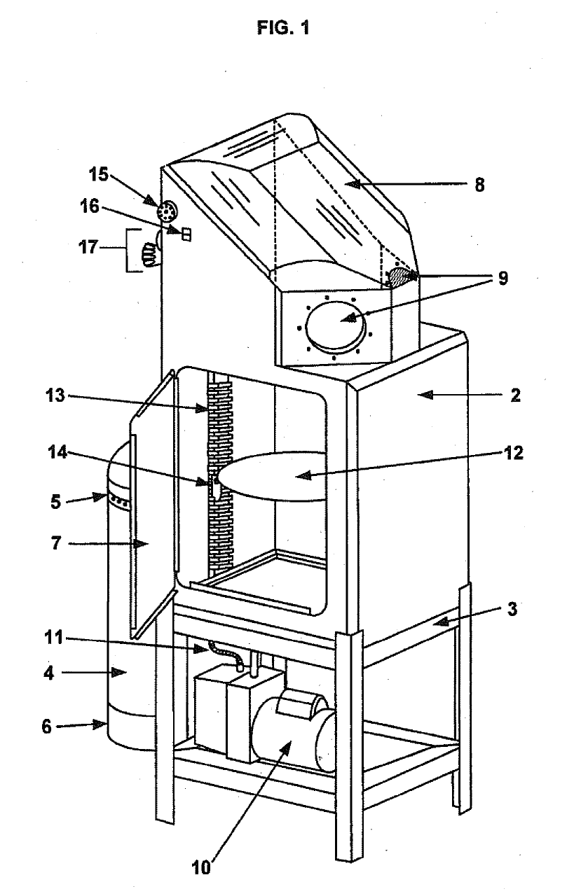

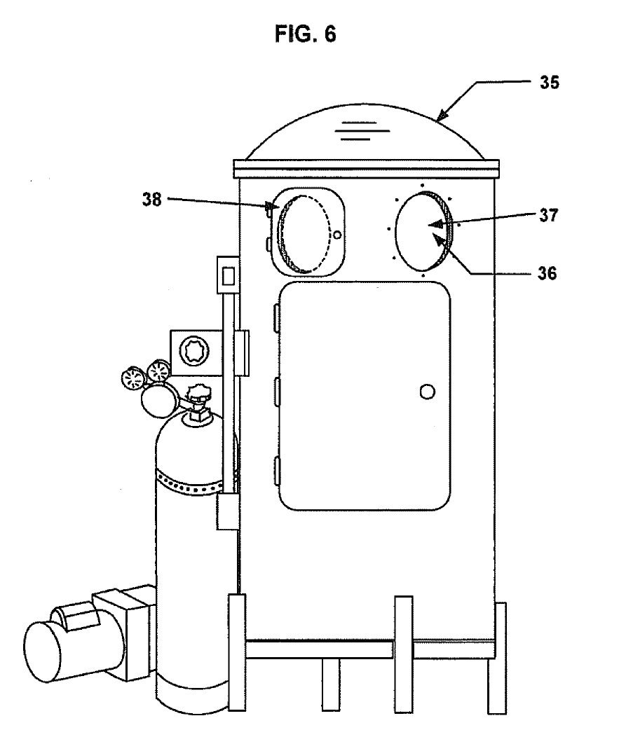

Referring now to FIGS. 1 through 6, the alcoholic beverage protection system (1) of one embodiment of the present invention is shown in FIG. 1. The system (1) of the present invention comprises a hermetically sealable chamber (2) dimensioned to receive one or more commonly sized alcoholic beverage containers. The chamber may be formed from any suitable material, including but not limited to steel alloys, such as stainless steel, aluminum alloys, brass, copper, or any sufficiently robust metal, etc. Chamber (2) may assume a variety of forms, anywhere from generally rectangular in cross-section to purely circular in cross-section, in the case of a cylindrical chamber (2) and as depicted in FIG. 6 and as more fully described below. The chamber (1) may also rest on an optional stand (3).

The inert gas to be infused into the chamber (2) may be from any type of gas supply system or gas container, such as a nitrogen generator or a conventional gas tank. An exemplary gas tank (4) is depicted. The gas tank may also be removably attached to the chamber (2) via either or both of a restraint collar (5) and a restraint “shoe” (6).

The chamber also has a sealable opening that may be sealed by a hatch or a door (7). The door (7) provides access to the interior of the chamber (2), and may be hingeably or slideably attached, either fixedly or removeably, to one side of the chamber (2). The door (7) may be constructed from the same material as the chamber (2) or from any other suitable material. When in the closed position, the door (7) may abut a sealing gasket (not depicted) that facilitates hermetic sealing of the chamber (2). The gasket may be made from any suitable material such as metal, ceramic, rubber, glass, fiberglass, TEFLON® or the like.

In one embodiment, such as the one depicted in FIG. 1, the system (1) may optionally also have a transparent top (8) integrally connected to the chamber (2), which may be constructed at least partially by a transparent material, such as plastic or glass. Underneath this top, two glove openings (9) are depicted through the chamber to which flexible gloves can optionally be sealably attached for manipulating the beverage containers inside the chamber.

The top may also be hingably and sealably connected to the chamber (2), such that the top portion can be opened up for ease of access during cleaning, etc. In another embodiment, the top may be completely separate, but capable of being sealably attached to the chamber (2) during operation of the system.

Any device for creating a vacuum in the chamber can be used in the practice of the present invention. For example, a conventional vacuum pump (10) can be used to create a negative pressure inside the chamber by pulling gas out of the chamber via a conduit such as a vacuum hose (11).

A platform (12) is disposed within the chamber (2) to support one or more bottles or beverage containers. In its most rudimentary form, the platform (12) is the bottom surface of the chamber (2), upon which the beverage containers are placed. However, as depicted in FIG. 1, the platform (12) may also be separate from the chamber (2), and may be moveably attached to the chamber (2) via a platform riser (13) that can be operated from the outside of the chamber to move the beverage containers up and down. The platform (12) as depicted in FIG. 1 is circular, however it may assume any desired cross-sectional shape, from rectangular to square to oval to hexagonal, etc. The platform (12) may also be constructed from any suitable material, including but not limited to metals, plastics, composites, etc. The platform (11) can be hingeably attached to the platform riser (13) via a platform riser bracket (14) that is adjustably and removably attached to the platform riser (13). The platform (12) also may be adapted to rotate about a swivel (not depicted) attached to the end of the platform riser bracket (14) arm. The platform (12) may also either be raised and lowered manually or automatically in a variety of ways, including but not limited to a piston arrangement, pneumatically extensible vertical risers, etc. In addition to supporting the beverage containers, the platform (12) may also be configured to securely hold the containers when the system is in use. When the platform (12) is in used as a beverage container holder, the chamber (2) may have a plurality of exchangeable platforms of various configurations for use with beverage containers of different sizes.

The chamber (2) further comprises actively controllable gas inlet and outlet ports in communication with the chamber (2) through either an individual hole or holes made in one or more walls of the chamber (2). Each of the actively controllable gas inlet and outlet ports (not shown) may be attached to the chamber through an individual hole on the chamber. Alternatively, some of the ports may also connected together and attached to the chamber through a single hole.

Other optional system components include an inside pressure gauge (15) that measures the pressure inside the chamber and a switch (16) operatively connected to the vacuum pump (9).

The system also includes a finite pressure gauge/regulator (17) that is used to control the flow of gas into the chamber (2) and thus also controls the pressure inside the chamber during different phases of operation of the system.

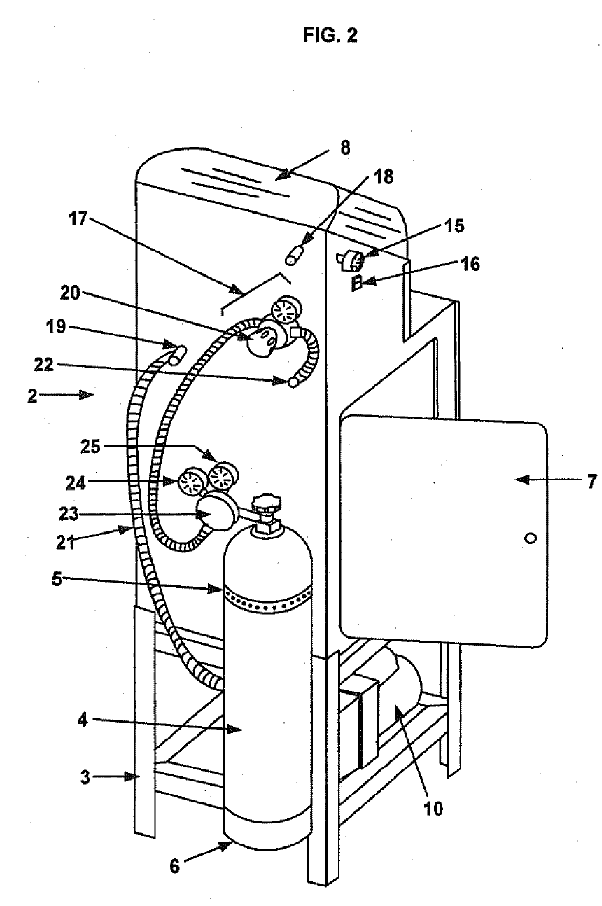

The rear of the system in FIG. 1 is depicted in FIG. 2. The chamber (2) includes the top (8) as a single integral unit. The top (8) allows a user to easily see the beverage containers disposed in the chamber (2).

In operation, the inside pressure gauge (15) on the chamber is first checked to ensure that the pressure inside the chamber (2) is at ambient pressure. The pressure is readily adjusted through a passive gas release T-valve (19) attached to the back side of the chamber (2) which, when in operation, functions passively to let gas escape when the chamber (2) is pressurized. The door (7) is then opened and one or more beverage containers are securely placed on the platform (not depicted). Tapping devices for the containers may also be placed inside the chamber. After the door (7) is closed, gas is removed from the chamber to create a negative pressure thereby removing oxygen and atomospheric microbial contaminants from the inside by turning on a vacuum T-valve (19) operatively connected to the gas outlet port (not depicted since its view is blocked by the vacuum T-valve (19)) that allows gas to exit the gas outlet port. This allows a negative pressure (i.e., less than ambient pressure) to be formed inside the chamber (2). Accordingly, the term “actively controllable outlet port” refers to the fact that the volume of gas that exits the chamber over time can be actively controlled by operation of the valve and vacuum pump system just described to achieve the desired negative pressure.

After closing the vacuum valve, the pressure valve/regulator (17) is operated by turning a gas control valve (20) to the open position, which allows gas to travel from the tank (4) through the gas hose (21) via the pressure valve/regulator (17) and into the chamber via a gas hose T-valve (22) operatively connected to the inlet port (also not depicted since its view is blocked by the gas hose T-valve (22)). This allows the inert gas from tank (4) to fill the chamber (2) thus returning the pressure of the chamber (2) to ambient pressure or slightly positive pressure. Of course, this requires that the gas tank valve/regulator (23) be in the “open” position. The gas input can be further controlled by monitoring an optional gas fill gauge (24) and gas pressure gauge (25). Each container inside the chamber (2) is then opened and resealed with a tapping device. Similarly to the outlet port, the inlet port is considered “actively controllable by operation of the valve and tank system just described to achieve the desired ambient or slightly positive pressure.

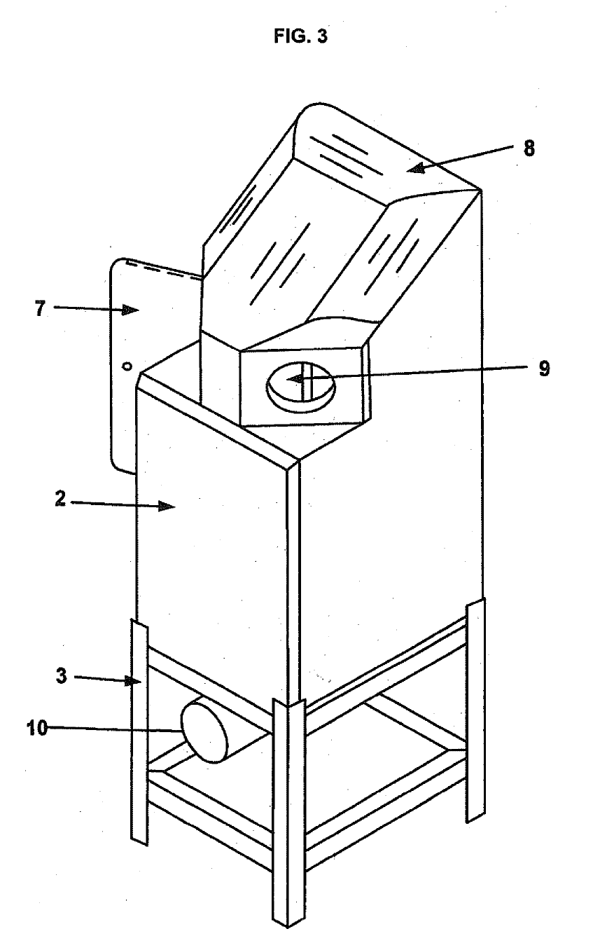

FIG. 3 is an alternate view of the system embodiment depicted in FIGS. 1 and 2, with a more “top down” perspective.

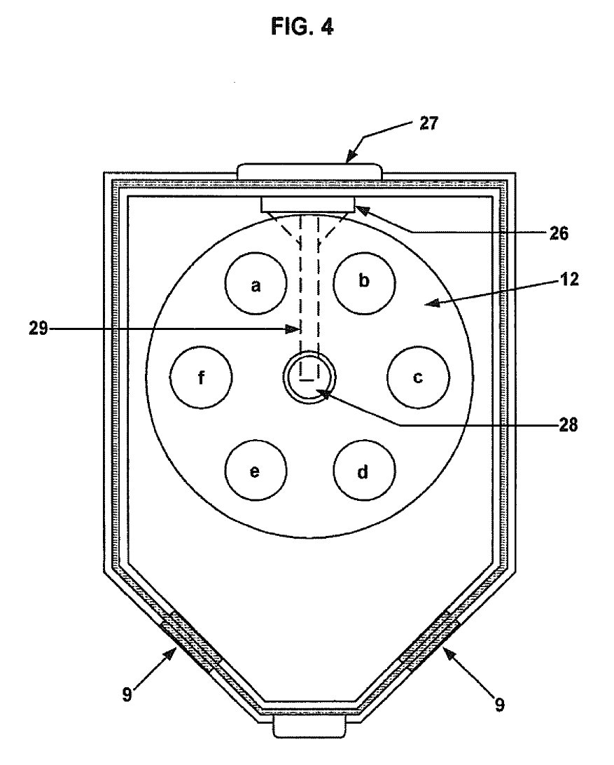

FIG. 4 is a top-down cross section view of the chamber depicting an embodiment of the platform (12) designed to hold six separate beverage containers in openings a-f. Also depicted is an adjustable tray positioner (26) and an optional hinge (27) for opening up the top as described above. An optional tapping device holder (28) is depicted in the middle of the platform (12). The placement of an optional swivel arm (29) is also shown.

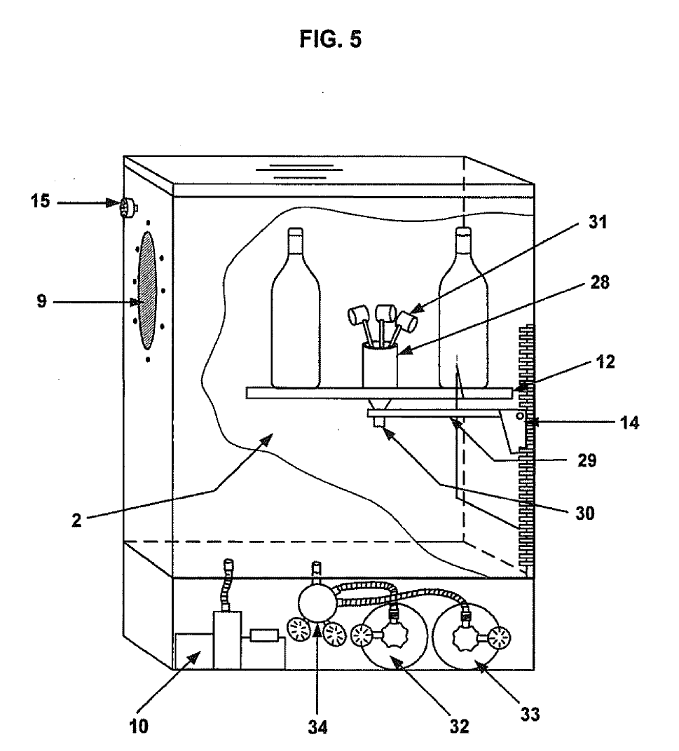

FIG. 5 is a side view of an alternative embodiment of the system of the present invention that depicts the operational configuration of the platform (12) from FIG. 4, and shows the swivel arm (29) attached to the adjustable bracket (14), which connects to a swivel joint (30) that allows the platform (12) to be moved about the center axis for better access to the beverage containers. Also depicted is the tapping device holder (28) which holds tapping devices (31). In this embodiment, two separate gas tanks (32 and 33) are depicted beneath the chamber (2) which each may contain nitrogen and carbon dioxide, respectively, that can be controlled via pressure valve/regulator (34).

FIG. 6 depicts a cylindrical embodiment of the system of the present invention. As shown, the top is in the form of a dome (35). An optional outer glove door (36) acts to protect the structurally attached gloves from the pressure differential that exists when the chamber device is depressurized. These doors function by segregating the trapped air from inside the gloves from the ambient environment. In so doing, while the chamber's inner volume pressure is decreased, there is less of a pressure build up inside the gloves themselves. The location of an optional integral perforated glove restraint (37) and tether system (38) is also depicted. This restraint may be used to protect the gloves from internal pressure build up during the depressurizing stage of operation and to protect the contents of the chamber from the inflation of the gloves, if trapped air inside the gloves is not eliminated prior to depressurizing.

As shown, the top is in the form of a dome (35). An optional outer glove door (36) is also shown, which may also include an integral perforated glove restraint (37) and tether (38).

The examples set forth above are provided to give those of ordinary skill in the art with a complete disclosure and description of how to make and use the preferred embodiments of the present invention, and are not intended to limit the scope of what the inventors regard as their invention. Modifications of the above-described modes (for carrying out the invention that are obvious to persons of skill in the art) are intended to be within the scope of the following claims. All publications, patents, and patent applications cited in this specification are incorporated herein by reference as if each such publication, patent or patent application were specifically and individually indicated to be incorporated herein by reference.

What is claimed is:

1. An alcoholic beverage protection system for reducing deterioration of a beverage in a container, comprising:
a hermetically sealable chamber having at least one sealable opening for receiving at least one beverage container, and at least one actively controllable gas inlet port and at least one actively controllable outlet port;
a platform disposed within the chamber for supporting the beverage container or containers; and
an inside pressure gauge operatively coupled to the chamber to monitor the gas pressure inside the chamber;
wherein the gas inlet port and the gas outlet port are operably configured to effect both a positive or ambient pressure, and a negative pressure, within the chamber.

2. A combination alcoholic beverage protection system and a tapping device, wherein the combination protects an alcoholic beverage in a beverage container from deterioration, comprising:
the alcoholic beverage protection system of claim 1; and
a tapping device adapted to attach to the beverage container, wherein the tapping device is configured to reduce deterioration of the beverage after removal of the beverage container from the alcoholic beverage protection system.

3. The alcoholic beverage protection system of claim 1, further comprising a vacuum pump and a gas tank.

4. The alcoholic beverage protection system of claim 1, wherein the chamber further comprises a transparent top.

5. The alcoholic beverage protection system of claim 1, further comprising a platform riser disposed within the chamber and operably connected to the platform to raise the platform up and down.

6. The alcoholic beverage protection system of claim 1, further comprising one or more flexible gloves sealably connected to the chamber through one or more corresponding openings in the chamber.

7. A method of exchanging an alcoholic beverage container closure with a tapping device to reduce deterioration of an alcoholic beverage in an alcoholic beverage container, comprising the steps of:
a) providing a hermetically sealable chamber having at least one sealable opening for receiving at least one beverage container, and at least one actively controllable gas inlet port and at least one actively controllable outlet port;
b) placing the alcoholic beverage container and the tapping device into the chamber;
c) removing atmospheric gases and microbial contaminants from the chamber;
d) filling the chamber with an inert gas; and
e) exchanging the closure with the tapping device.
